(19) United States
(12) Patent Application Publication
(10) Pub. No.: US 2001/0055209 A1
(43) Pub. Date: Dec. 27, 2001

(54) Light projector, particularly for projecting light with variable dimensions and coloring

(75) Inventor: Bruno Dedoro, Goffredo (IT)

Correspondence Address: MODIANO & ASSOCIATI, Via Meravigli, 16, MILANO, 20123, IT

(73) Assignee: COEMAR S.p.A.

(21) Appl. No.: 09/862,603

(22) Filed: May 23, 2001

(30) Foreign Application Priority Data
Jun. 27, 2000 (IT) MI2000A001444

(51) Int. Cl. F21V 9/00

(52) U.S. Cl. 362/293; 362/268; 362/277; 362/319

(57) ABSTRACT

A light projector, particularly for projecting light with variable dimensions and coloring, comprising, on a light beam emitted by a light source, a color changing unit, the light projector further comprising a zoom device being constituted by a first antihalation or Fresnel lens which can move with respect to a second fixed lens, the first and second lenses being arranged downstream of the color changing unit.

### BACKGROUND OF THE INVENTION

The present invention relates to a light projector, particularly for projecting light with variable dimensions and coloring.

It is known that the light projectors used, for example, in the field of entertainment generally comprise a light source on the light beam whereof a filtering element is interposed in order to provide the intended coloring of the beam.

The solutions currently in use do not allow to obtain a full color spectrum, since the coloring depends on the combination of filtering elements which necessarily must be limited in their number and accordingly cannot cover the entire color spectrum. Moreover, in the solutions of the prior art it is not possible to easily adjust the width of the resulting light beam, thus having projectors which are very bulky and difficult to maneuver.

Known types of projector do not allow to achieve these effects.

### SUMMARY OF THE INVENTION

The aim of the present invention is to provide a light projector particularly for projecting light with variable beam dimensions, i.e. with the so called “zoom effect”, and coloring, so as to vary the angle of the projected beam of light.

Within this aim, an object of the present invention is to provide a light projector, particularly for projecting light with variable dimensions and coloring, which allows to obtain, with structurally simple means, a very high range of colors, by being able to combine in the various shades the three complementary colors, i.e., cyan, magenta and yellow.

Another object of the present invention is to provide a light projector which allows to obtain the zoom effect with a mechanism which is simple and at the same time highly reliable.

Another object of the present invention is to provide a light projector in which the zoom effect is achieved by using commonly commercially available lenses.

Another object of the present invention is to provide a light projector, particularly for projecting light with variable dimensions and in an infinite of colors, which is highly reliable, relatively simple to manufacture and at competitive costs.

This aim and these and other objects which will become better apparent hereinafter are achieved by a light projector, particularly for projecting light with variable dimensions and coloring, comprising, on a light beam emitted by a light source, a color changing unit, characterized in that it further comprises a zoom device which is constituted by a first antihalation lens which can move with respect to a second fixed lens, said first and second lenses being arranged downstream of the color changing unit.

### BRIEF DESCRIPTION OF THE DRAWINGS

Further characteristics and advantages of the invention will become better apparent from the description of a preferred but not exclusive embodiment of a light projector for projecting light with variable dimensions and coloring, illustrated only by way of non-limitative example in the accompanying drawings, wherein:

FIG. 1 is an optical diagram of the projector according to the invention, with the lenses for providing the zoom effect;

FIG. 1a is an optical diagram of the projector according to the invention, according to a second embodiment;

FIG. 2 is an exploded perspective view of the optical projector according to the invention;

FIG. 3 is a perspective view of the zoom mechanism combined with the optical projector according to the invention, with the lenses in a first position; and

FIG. 4 is a perspective view, similar to FIG. 3, of the zoom mechanism with the lenses in a second position.

### DESCRIPTION OF THE PREFERRED EMBODIMENTS

With reference to the figures, the optical projector according to the present invention, generally designated by the reference numeral 1, comprises a light source 2 which is constituted for example by a high-power discharge lamp with the associated parabolic reflector, which emits an unfocused light beam.

Downstream of the light source 2, as referred to the light propagation direction, a dimmer 4 is provided being arranged in front of a color changing unit, generally designated by the reference numeral 3, which is constituted by a mechanical system with six motors in number, two for each complementary color, i.e., cyan, magenta and yellow.

The color changing unit 3 has, for each complementary color, two sectors arranged symmetrically to each other and having a central body which can engage a rotation pivot.

A toothed sector is connected to the central body and meshes with an actuation motor.

The features of the color changing units are illustrated in EPA-00119304.4 by the same Applicant.

Downstream of the color changing unit, along the light propagation direction, it is possible to provide a wheel 6a on which the dichroic colors and a filter 6b are fitted.

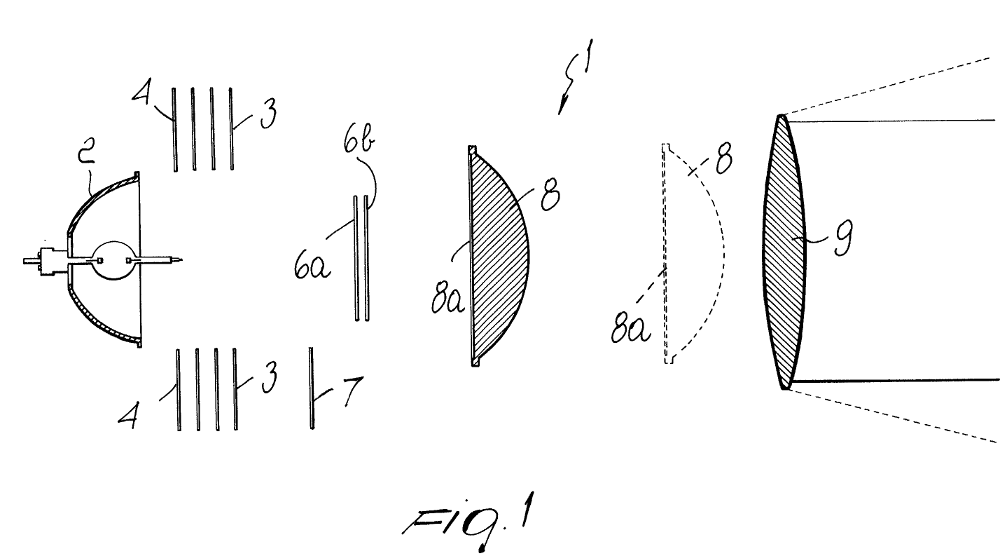

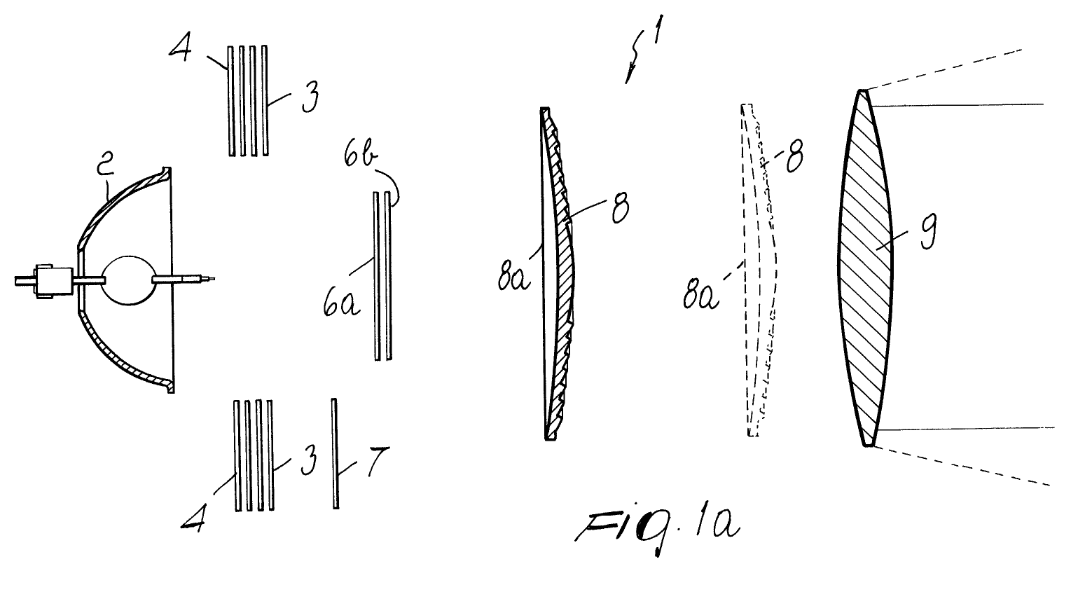

The zoom assembly comprises a first antihalation lens 8 (FIG. 1), with studs 8a provided on the flat surface. The term “antihalation lens” designates a lens with studs on its flat surface which lies opposite a curved surface.

The lens 8 can suitably move towards or away from a second fixed lens 9, for example of the biconvex type, which is manufactured with an antireflection treatment.

The lens 8 can also be provided by means of a Fresnel lens with studs on its concave surface that lies opposite the typical Fresnel etching with concentric circles.

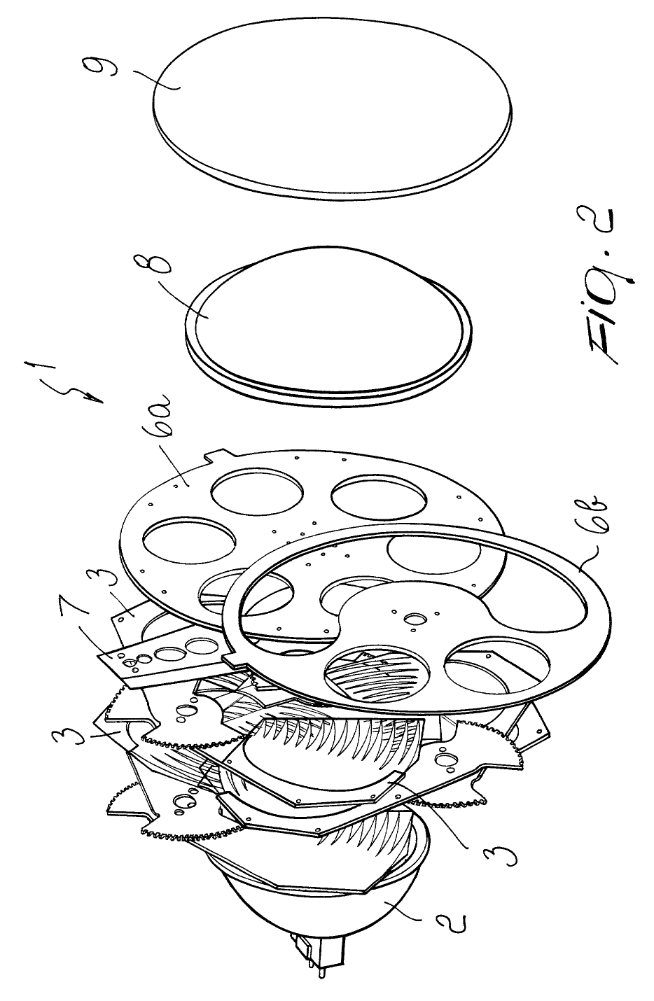

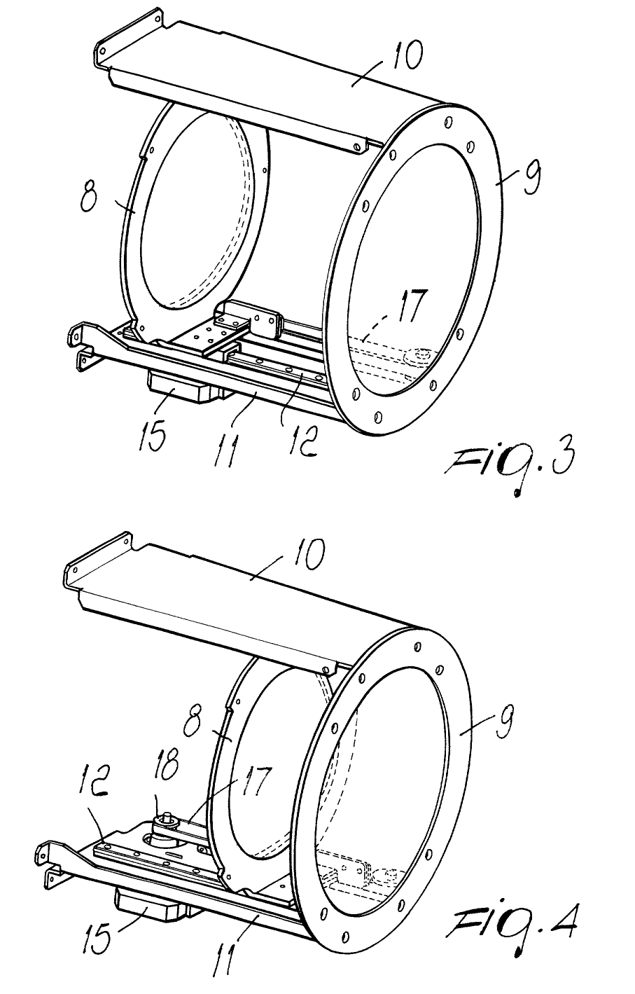

The movement of the antihalation or Fresnel lens 8 with respect to the fixed lens 9 is shown in detail in FIGS. 3 and 4. In particular, the fixed lens 9 is stably supported by an upper frame 10 and by a lower frame 11 which define a movement path for the antihalation or Fresnel lens 8. Said lens can suitably slide along a guide 12, for example by means of a lens movement system of the belt and pulley type or rack type.

FIGS. 3 and 4 illustrate the belt drive, in which the reference numeral 15 designates motor means and the reference numeral 17 designates a belt with a corresponding pulley 18.

In this manner, the movement of the lens 8 with respect to the lens 9, towards or away from it, allows to vary the angle of the light beam projected by the light source 2.

The surface treatment of the movable lens 8, i.e., the studs 8a formed on its flat surface, allows to diffuse the light beam and make it uniform.

A shutter 7 can be provided between the color changing unit 3 and the wheel 6a.

The light projector according to the invention thus allows, with a zoom mechanism which is extremely, simple, i.e. constituted by a first antihalation or Fresnel lens 8 which can move and by a second lens 8 which is fixed, to achieve a variation of the angle of the light beam projected by the light source 2, thus allowing to vary the dimensions of the projected beam.

The above described system is highly reliable owing to the small number of elements that compose the zoom mechanism.

In practice it has been observed that the light projector according to the invention fully achieves the intended aim and objects, since it allows to vary the dimensions of the light beam projected by the light source, using a single lens which can move with respect to a fixed lens, both lenses being arranged downstream of the discharge lamp.

The light projector thus conceived is susceptible of numerous modifications and variations, all of which are within the scope of the appended claims.

All the details may further be replaced with other technically equivalent elements.

In practice, the materials used, so long as they are compatible with the specific purpose, and the dimensions, may be any according to requirements and to the state of the art.

The disclosures in Italian Patent Application No. MI2000A001444 from which this application claims priority are incorporated herein by reference.

What is claimed is:

1. A light projector for projecting light with variable beam dimensions and colors, comprising: a light source for emitting a light beam; a color changing unit; a zoom device, constituted by a first antihalation lens and by a second lens arranged downstream of said color changing unit, along a propagation direction of the light beam, said first lens being movable with respect to the second lens which is fixed.

2. A light projector for projecting light with variable beam dimensions and coloring comprising: a light source for emitting a light beam; a color changing unit; a zoom device constituted by a first Fresnel lens and by a second lens arranged downstream of said color changing unit, along a propagation direction of said light beam, said first lens being movable with respect to the second fixed lens.

3. The light projector of claim 1, further comprising motor means provided at said first movable lens for moving the first lens toward and away from said second fixed lens.

4. The light projector of claim 3, wherein said motor means comprise a belt drive including a driving motor and a driven belt.

5. The light projector of claim 4, further comprising: a supporting frame; a guide formed at said frame; and engagement means provided at said movable lens to enable sliding of said movable lens under actuation of said motor means along said guide.

6. The light of claim 1, wherein said antihalation lens is provided with a studded flat surface which is directed towards said light source.

7. The light projector of claim 1, wherein said fixed lens is of a biconvex type.

8. The light projector of claim 1, wherein said fixed lens has an antireflection treatment.

9. The light projector of claim 3, further comprising a mechanical dimmer element arranged along the propagation direction of the light beam, between said light source and said color changing unit.

10. The light projector of claim 9, further comprising a filter, a shutter device and a wheel with dichroic colors, all of which being arranged along the propagation direction of the light beam, between said color changing unit and said movable lens.
